(19) United States
(12) Patent Application Publication
(10) Pub. No.: US 2020/0338731 A1
(43) Pub. Date: Oct. 29, 2020

(54) MOBILE ROBOTIC CAMERA PLATFORM

(71) Applicants: Michael L. Lynders, Shelton, CT (US); Kacper Laska, Bristol, CT (US)

(72) Inventors: Michael L. Lynders, Shelton, CT (US); Kacper Laska, Bristol, CT (US)

(21) Appl. No.: 16/857,997

(22) Filed: Apr. 24, 2020

Related U.S. Application Data
(60) Provisional application No. 62/838,543, filed on Apr. 25, 2019.

(51) Int. Cl. B25J 9/16; B25J 19/02

(52) U.S. Cl. CPC B25J 9/1664; B25J 9/1669; B25J 19/023; B25J 9/162

(57) ABSTRACT

Methods, apparatus, and processor-readable storage media for a mobile robotic camera platform are provided herein. An example apparatus includes a frame; a multi-wheeled motorized base connected to the frame, wherein the multi-wheeled motorized base provides one or more translational axes; one or more electric actuators connected to the multi-wheeled motorized base; a set of one or more sensors configured to determine a location of the apparatus relative to a given environment; and a control system comprising at least one algorithm configured to process data measured by the set of one or more sensors and engage at least a portion of the one or more electric actuators based at least in part on the processed data.

### CROSS-REFERENCE TO RELATED APPLICATIONS

The present application claims priority to U.S. Provisional Application Ser. No. 62/838,543, filed Apr. 25, 2019, incorporated by reference herein.

### FIELD

The field relates generally to information technology, and more particularly to multimedia technology.

### BACKGROUND

Conventional camera motion control systems typically include substantial cranes and/or rail systems. Such physically large and complicated componentry is often cost-prohibitive for many users (such as filmmakers) and creates logistical challenges related to obtainment, storage, and/or implementation. Additionally, as is generally understood, each direction that a camera can move (forward, backward, up, down, clockwise, counter-clockwise, etc.) is commonly referred to as an axis. With conventional camera motion control systems, an increase in the number of axes renders the camera more versatile but introduces significant costs and complexity. Additionally, other conventional filmmaking options include utilizing manually-operated equipment, which involves problems related to scalability, flexibility, and the incurrence of additional labor and related costs.

Accordingly, a need exists for a portable camera motion control system that is capable of operating without traditional cranes and rail components.

### SUMMARY

Illustrative embodiments of the invention provide a mobile robotic camera platform. In an example embodiment, an exemplary apparatus includes a frame, a multi-wheeled motorized base connected to the frame, wherein the multi-wheeled motorized base provides one or more translational axes, and one or more electric actuators connected to the multi-wheeled motorized base. The apparatus also includes a set of one or more sensors configured to determine a location of the apparatus relative to a given environment, and a control system comprising at least one algorithm configured to process data measured by the set of one or more sensors and engage at least a portion of the one or more electric actuators based at least in part on the processed data.

In another embodiment, a computer-implemented method includes recording motion data of a mobile robotic camera platform, wherein the motion data corresponds to a user-designed set of movements, and generating modified motion data by applying one or more smoothing algorithms to the recorded motion data. The method also includes configuring the mobile robotic camera platform to automatically perform a set of movements corresponding to the modified motion data, wherein configuring the mobile robotic camera platform comprises implementing one or more motion control algorithms. Further, the method includes detecting and adjusting movement of the mobile robotic camera platform during performance of the set of movements corresponding to the modified motion data by implementing one or more sensors.

Illustrative embodiments can provide significant advantages relative to conventional camera motion control systems. For example, challenges associated with portability and cost are overcome through precluding the need of cranes and rail systems by implementing specialized wheel modules in conjunction with the implementation of motion sensors and automated data smoothing algorithms.

These and other illustrative embodiments described herein include, without limitation, methods, apparatus, networks, systems and processor-readable storage media.

### BRIEF DESCRIPTION OF THE DRAWINGS

FIG. 1 is a block diagram of a network configured for implementation of a mobile robotic camera platform in an example embodiment of the invention;

FIG. 2 is a diagram illustrating a mobile robotic camera platform in an example embodiment of the invention; and

FIG. 3 is a flow diagram of a process for operating a mobile robotic camera platform in an illustrative embodiment of the invention.

### DETAILED DESCRIPTION

As detailed herein, one or more embodiments of the invention include a mobile robotic camera platform.

Example and/or illustrative embodiments of the invention will be described herein with reference to exemplary networks and associated computers, servers, network devices or other types of processing devices. It is to be appreciated, however, that the invention is not restricted to use with the particular illustrative network and device configurations shown. By way of example, the term “network” as used herein is intended to be broadly construed, so as to encompass, for example, any system comprising multiple networked processing devices.

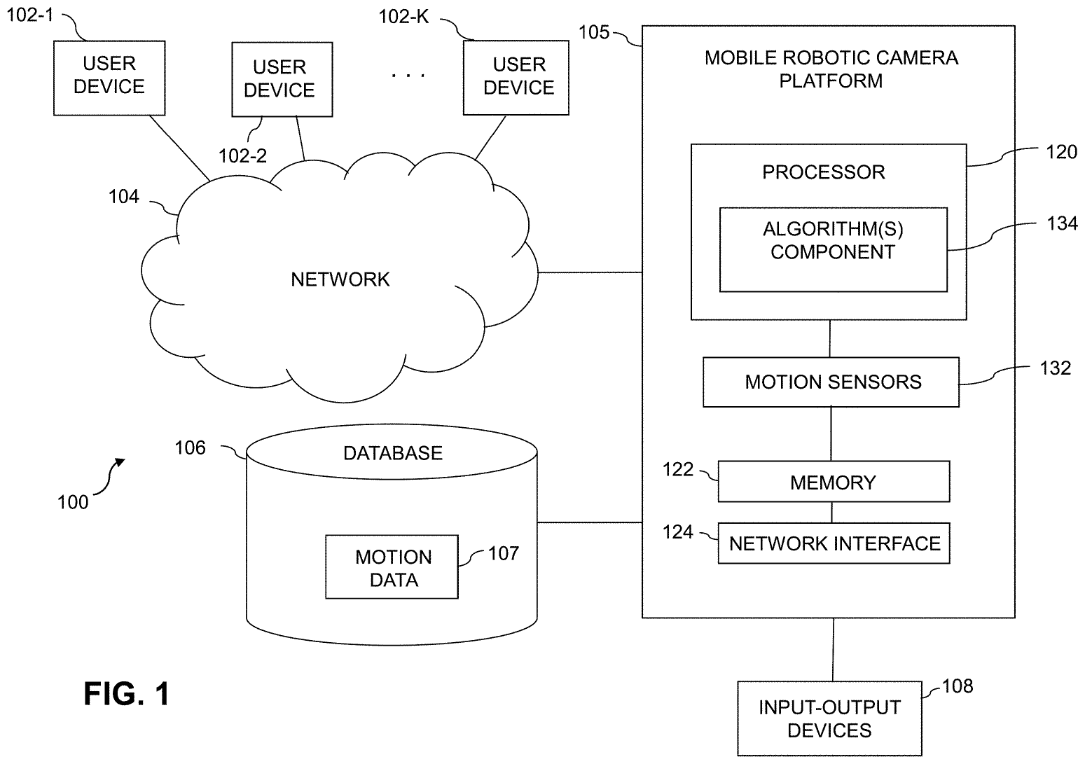

FIG. 1 shows a network 100 configured in accordance with an example embodiment of the invention. The network 100 includes a plurality of user devices 102-1, 102-2, . . . 102-K, collectively referred to herein as user devices 102. The user devices 102 are coupled to a network 104, where the network 104 in such an embodiment is assumed to represent a sub-network or other related portion of the larger network 100. Accordingly, elements 100 and 104 are both referred to herein as examples of “networks,” but element 104 is assumed to be a component of element 100 in the context of the FIG. 1 embodiment. Also coupled to the network 104 is mobile robotic camera platform 105.

The user devices 102 can include, for example, cinema cameras, mobile telephones, laptop computers, tablet computers, desktop computers or other types of computing devices. The user devices 102, as illustrated in FIG. 1, can connect (wirelessly or via a hard-wired connection) to the mobile robotic camera platform 105 via network 104.

In one or more embodiments of the invention, each user device 102 is assumed to be implemented using at least one processing device. Each such processing device generally includes at least one processor and at least one associated memory, and implements one or more functional software modules or components for controlling certain features of the user device 102.

Similarly, in at least one embodiment of the invention, the mobile robotic camera platform 105 in the FIG. 1 embodiment can be implemented using at least one processing device. Each such processing device can include at least one processor and at least one associated memory, and can implement one or more functional software modules or components for controlling certain features (such as, for example, adjusting the position and/or velocity of one or more axes or motions) of the mobile robotic camera platform 105.

In the example embodiment of the invention illustrated in FIG. 1, the mobile robotic camera platform 105 includes a processor 120 coupled to a memory 122 and a network interface 124 (as well as to motion sensors 132, further detailed below).

The processor 120 can include, for example, a microprocessor, a microcontroller, an application-specific integrated circuit, a field-programmable gate array or other type of processing circuitry, as well as portions or combinations of such circuitry elements.

The memory 122 can include, for example, random access memory (RAM), read-only memory (ROM) or other types of memory, in any combination. The memory 122 and other memories disclosed herein can also be viewed as examples of processor-readable storage media, which can store executable computer program code and/or other types of software programs.

Examples of such processor-readable storage media can include, by way merely of example and not limitation, a storage device such as a storage disk, a storage array or an integrated circuit containing memory, as well as a wide variety of other types of computer program products. The term “processor-readable storage media” as used herein should be understood to exclude transitory, propagating signals.

The network interface 124 allows the mobile robotic camera platform 105 to communicate over the network 104 with the user devices 102, and can include, for example, one or more conventional transceivers.

Additionally, the user devices 102 can be coupled to one or more additional devices such as mobile telephones, laptop computers, tablet computers, desktop computers or other types of computing devices. The user devices 102, in one or more embodiments of the invention, can be coupled to respective computers associated with a particular company, organization or other enterprise. In addition, at least portions of the network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” herein is intended to be broadly construed so as to encompass, for example, human, hardware, software or firmware entities, as well as various combinations of such entities.

The network 104 is assumed to include a portion of a global computer network such as the Internet, although other types of networks can be part of the network 100, including a wide area network (WAN), a local area network (LAN), a satellite network, a telephone or cable network, a cellular network, a wireless network such as a Wi-Fi or WiMAX network, or various portions or combinations of these and other types of networks. Also, the network 100, in one or more embodiments of the invention, can include combinations of different types of networks, each including processing devices configured to communicate using internet protocol (IP) or other related communication protocols.

The mobile robotic camera platform 105 has an associated database 106 configured to store data related to the mobile robotic camera platform 105. The database 106 more particularly stores motion data 107 pertaining, for example, to motion performed or to-be-performed by the mobile robotic camera platform 105.

In at least one embodiment of the invention, database 106 can be implemented using one or more storage systems associated with the mobile robotic camera platform 105. Such storage systems can comprise any of a variety of types of storage including network-attached storage, storage area networks, direct-attached storage and distributed direct-attached storage, as well as combinations of these and other storage types, including software-defined storage.

Also associated with the mobile robotic camera platform 105 are input-output devices 108, which can include, by way merely of example, keyboards, displays, human input devices (HIDs) such as joysticks or gamepads, or other types of input-output devices in any combination. Such input-output devices can be used to support one or more user interfaces (UIs) to the mobile robotic camera platform 105, as well as to support communication between the mobile robotic camera platform 105 and other related systems and devices not explicitly illustrated in FIG. 1.

Further, as depicted in FIG. 1, the mobile robotic camera platform 105 also includes motion sensors 132 (which can include, for example, one or more encoders, also referred to herein as joint encoders) and an algorithm(s) component 134. As specifically detailed in the example embodiment depicted in FIG. 1, the processor 120 can contain and/or execute the algorithm(s) component 134, as well as interface with motion sensors 132.

It is to be appreciated that this particular arrangement of modules 132 and 134 illustrated in the FIG. 1 embodiment is presented by way of example only, and alternative arrangements can be used in one or more other embodiments of the invention. For example, the functionality associated with the modules 132 and 134 in other embodiments can be combined into a single module, or separated across a number of modules. By way of further example, one or multiple distinct processors can be used to implement different ones of the modules 132 and 134, or portions thereof.

Also, by way of example, at least portions of the motion sensors 132 and algorithm(s) component 134 can be implemented at least in part in the form of software that is stored in memory 122 and executed by processor 120. Additionally or alternatively, the motion sensors 132 can interface to and/or communicate with software that is stored in memory 122 and executed by processor 120.

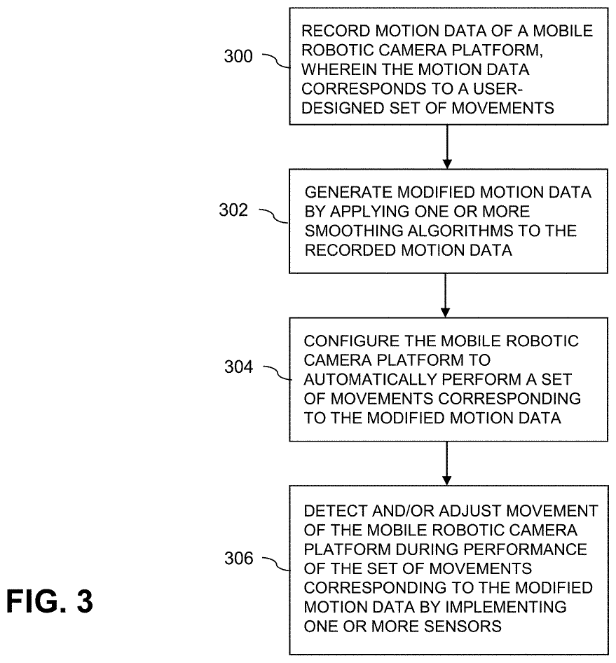

Further, an example process utilizing motion sensors 132 and algorithm(s) component 134 of the mobile robotic camera platform 105 in network 100 is described below, including in connection with the description of FIG. 3.

It is to be understood that the particular set of elements shown in FIG. 1 is depicted by way of illustrative example only, and in one or more other embodiments of the invention, additional or alternative elements may be used.

By way merely of example, in one or more other embodiments of the invention, the mobile robotic camera platform 105 can be eliminated and associated elements such as motion sensors 132 and algorithm(s) component 134 can be implemented elsewhere in network 100.

Accordingly, and as further detailed herein, at least one embodiment of the invention includes a mobile robotic camera platform for usage in such contexts, for example, as filmmaking, that allows a user (e.g., a filmmaker) to automatically execute camera movements without expensive and cumbersome equipment associated with conventional systems.

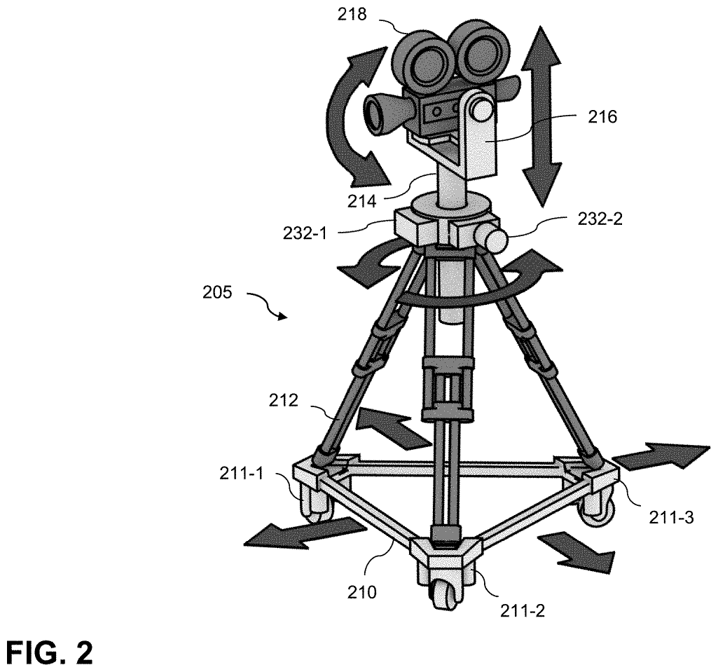

FIG. 2 is a diagram illustrating a mobile robotic camera platform 205 in an example embodiment of the invention. By way of illustration, FIG. 2 depicts a multi-wheeled (for example, a three-wheeled) robotic base 210 that utilizes a set of one or more sensors (such as motion sensors 132 in FIG. 1, for example) to accurately perform movements unconstrained by a track or rail system. In the example embodiment illustrated in FIG. 2, the (triangular) base 210, composed of wheel modules 211-1, 211-2, and 211-3, attaches to a frame 212. As noted herein, frame 212 can encompass a conventional tripod and/or one or more distinct rigid structures. As also detailed herein, the combination of wheel modules 211 and base 210 can encompass a multi-wheeled motorized base. In at least one embodiment, one or more actuators are integral to the wheel modules 211.

As also depicted in FIG. 2, a telescopic vertical actuator 214 attached to the mounting plate at the top of the frame 212 supports a gimbal 216, allowing the (cinema) camera 218 to move vertically and tilt. Also, the mobile robotic camera platform 205 includes sensors 232-1 and 232-2 (hereinafter collectively referred to as sensors 232), which can include and/or encompass a variety of sensor types as further detailed herein. Additionally or alternatively, one or more of the sensors 232 can be integral to and/or arranged in conjunction with at least one processor or processing unit.

At least one embodiment provides the benefit of increased efficiency over conventional systems, as such an embodiment enables camera movements to be programmed intuitively. In an example embodiment, an operator guides the mobile robotic camera platform (e.g., 105, 205) through a movement, for example, via user device 102 and/or input-output device 108 (e.g., a controller or joystick). By way merely of example, one or more embodiments include implementing a compliant method of programming (also referred to herein as a collaborative trajectory design) in which the mobile robotic camera platform can be pushed through a movement via the application of a small directional force by a user on one or more parts of the mobile robotic camera platform (for example, through the use of one or more input-output devices, such as a joystick or a user device such as a mobile phone). In such an embodiment, one or more actuators and/or sensors of the mobile robotic camera platform detect and augment the directional force of the user. This allows the user to direct the motion of the robot with little force, regardless of the mass of the mobile robotic camera platform. In this way, the mobile robotic camera platform complies (i.e., is “compliant”) to the force input of the user.

As further detailed here, one or more embodiments can include the utilization and/or implementation of other programming and/or operation methods. One such method, for example, can include a graphic trajectory design in which a computer-generated graphic representation of the trajectory is displayed in a user interface via three-dimensional graphics. The trajectory can be manipulated through software and loaded into the mobile robotic camera platform's memory for execution.

The mobile robotic camera platform (105, 205) records (and stores in memory 122 and/or database 106) the motion data with one or more encoders (e.g., positional sensors such as but not limited to a simultaneous localization and mapping (SLAM) camera, a stereoscopic camera, ultrasonic sensors, global positioning system (GPS) sensors, etc.) and applies one or more smoothing algorithms (via algorithm(s) component 134, for example) to the recorded motion data. When it comes time to subsequently perform the recorded movement(s), the motion data is retrieved (from memory 122 and/or database 106), executed, and recorded again, facilitating integration of computer generated visual elements.

By way of example, in one or more embodiments, motion data can include a position function and a velocity function, wherein such functions can be expressed as one or more look-up-tables of measured data and/or as parametric functions (e.g., in one such embodiment, a data smoothing algorithm can convert from a look-up-table to a parametric function).

As detailed herein, one or more embodiments include implementing a mobile robotic camera platform that does not require operation on a rail system or the use of one or more cranes. Such an embodiment includes combining the X, Y, and Z-rotation (yaw) axes via creation and implementation of a specialized wheel module in which the heading of each wheel can be actuated independently. Accordingly, instead of requiring the use of a rail system, such a mobile robotic camera platform is capable of driving/moving on the ground in any direction. This ability eliminates the need for a crane arm and expensive rail systems, thereby greatly simplifying the mechanical structure of the motion controls rig. It should be understood that the wheel implementation described above is only one of many possible wheel configurations possible. Other example possibilities include differential-drive, holonomic drive, or some other arrangement of wheels providing at least two degrees of freedom.

As detailed herein, one or more embodiments include implementing independently actuated wheels, along with novel wheel modules, to achieve omnidirectional mobility. However, it is to be appreciated that other embodiments can include utilizing other forms of mobile wheelbases used for mobile robotics (e.g., different wheel-bases suited for different floor surfaces, speeds, etc.).

In at least one embodiment, the mobile robotic camera platform utilizes one or more onboard computer implementing algorithms such as a proportional-integral-derivative (PID) controller system, trajectory planning, etc., in order to carry out movements with precision. Additionally or alternatively, one or more embodiments include implementing at least one motion smoothing algorithm subsequent to motion data having been obtained and/or captured. When the device replays the obtained and/or captured motion (data), multiple algorithms are applied to control the motion of the mobile robotic camera platform. In such an embodiment, this process repeats many times per second. Accordingly, one or more embodiments can include implementing a workflow that includes the following sequence: (i) sensor sampling, data fusion, and SLAM, (ii) trajectory planning and execution, (iii) inverse kinematics, and (iv) closed-loop feedback control.

As noted, such an embodiment includes utilizing sensor fusion of wheel encoders, also referred to herein as joint encoders (e.g., odometry), at least one stereoscopic camera, and an inertial measurement unit (IMU) to accurately detect the platform's motion. Other forms of position tracking can also be implemented to improve accuracy in one or more embodiments. Further, in at least one embodiment, the mobile robotic camera platform records its movement data and feeds the data to one or more graphics program to adjust any computer generated imagery to match the movement data exactly as performed.

By freeing the apparatus from a rail system and/or crane, the mobile robotic camera platform is rendered significantly more portable (e.g., smaller and lighter, with increased range) than conventional systems. The camera can remain on the mobile robotic camera platform for a wide variety of moving and static shots, maximizing camera availability time, and minimizing setup time in-between shots. Additionally, because the mobile robotic camera platform, in one or more embodiments, can perform movements from a memory, a crew can have all of the desired and/or required movements choreographed and pre-loaded into the mobile robotic camera platform for one or more shots, eliminating the need to rehearse camera movements and break down and set-up large and cumbersome equipment.

As further detailed herein, in implementations wherein movements are not preloaded, the mobile robotic camera platform can be controlled to move to setpoint positions by an operator, and then the mobile robotic camera platform can automatically interpolate smooth motion between each setpoint. Thus, in one or more embodiments, camera movements can be generated quickly (on set, for example), rather than exclusively relying on a three-dimensional (3D) graphics program. Such an embodiment provides a user (such as a filmmaker, for example) with the ability to make creative filming and/or shooting changes on-the-fly without waiting for equipment to be assembled and/or reconfigured.

FIG. 3 is a flow diagram of a process for operating a mobile robotic camera platform in an illustrative embodiment of the invention. In this embodiment, the process includes steps 300 through 306. These steps, in one or more embodiments, are assumed to be performed utilizing modules such as 132 and/or 134 from the FIG. 1 example embodiment.

Step 300 includes recording motion data of a mobile robotic camera platform, wherein the motion data corresponds to a user-designed set of movements. In at least one embodiment, the user-designed set of movements can include movements of the mobile robotic camera platform manipulated manually or via one or more input devices, movements of the mobile robotic camera platform constrained by a control system to at least a two-dimensional virtual path stored in memory, wherein velocity of the mobile robotic platform on the virtual path is user-controlled, and/or automated movement of the mobile robotic camera platform between two or more user-determined setpoints. Additionally, in one or more embodiments, the motion data can include at least one computer-generated graphic representation of movements of the mobile robotic camera platform.

Step 302 includes generating modified motion data by applying one or more smoothing algorithms to the recorded motion data. Step 304 includes configuring the mobile robotic camera platform to automatically perform a set of movements corresponding to the modified motion data, wherein configuring the mobile robotic camera platform includes implementing one or more motion control algorithms. In at least one embodiment, implementing the one or more motion control algorithms includes implementing (i) at least one algorithm directed to sensor sampling, fusion, and simultaneous location and mapping, (ii) at least one algorithm directed to trajectory planning and execution, (iii) at least one algorithm directed to inverse kinematics, and (iv) at least one algorithm directed to closed-loop feedback control.

With respect to the at least one algorithm directed to sensor sampling, fusion, and simultaneous location and mapping, data from one or more sensors are processed using one or more filters to improve the signal quality. In the case of some sensors (such as position sensors including stereoscopic camera, joint encoders, GPS sensors, etc.), a fusion algorithm combines data from multiple sensors to provide a more accurate signal than any one sensor provides individually (due to constraints such as update frequency, accrued errors, etc.). Additionally, simultaneous location and mapping is a more specific fusion algorithm for constructing and/or updating a map of an unknown environment while simultaneously keeping track of the mobile robotic camera platform's location within the environment.

With respect to motion smoothing, at least one embodiment includes taking as input motion data (e.g., a representation of the mobile robotic camera platform's motions (for example, in the form of a look-up-table)) and removing high-frequency motions that would appear distracting and unsightly in footage recorded by an attached cinema camera.

The at least one algorithm directed to trajectory planning and execution can include a high-level program that fuses multiple motion data inputs (such as, for example, a predefined trajectory, or inputs from input-output devices such as a user device or joystick into the motion of the end-effector (that is, a given point on the mobile robotic camera platform such as, for example, a mounted cinema camera)).

With respect to the at least one algorithm directed to inverse kinematics, such an algorithm determines the motions of all individual joints of the mobile robotic camera platform (including, for examples, wheels) needed to achieve the desired location of the end effector (e.g., cinema camera). The output of such an algorithm can be consumed by one or more closed-loop feedback control algorithms corresponding to the moveable joints of the mobile robotic camera platform. That said, the at least one algorithm directed to a closed-loop feedback control can be applied to ensure that the mobile robotic camera platform performs its motions and/or movements precisely.

Step 306 includes detecting and/or adjusting movement of the mobile robotic camera platform during performance of the set of movements corresponding to the modified motion data by implementing one or more sensors such as wheel encoders or joint encoders (e.g., for odometry purposes), one or more imaging sensors (e.g., a SLAM camera), one or more IMUs, etc. One or more embodiments can include repeating certain movements one or more times as necessary to record multiple shots using the mobile robotic camera platform.

As also detailed herein, at least one embodiment includes generating and/or implementing an apparatus that includes a frame, and a multi-wheeled motorized base connected to the frame, wherein the multi-wheeled motorized base provides one or more translational axes.

Such an apparatus also includes one or more electric actuators connected to the multi-wheeled motorized base, and a set of one or more sensors configured to determine a location of the apparatus relative to a given environment. The one or more sensors can include, for example, one or more joint encoders, one or more rotational encoders configured to measure a rotational position of at least a portion of the one or more electric actuators, and/or one or more imaging sensors integral to the apparatus and positioned pointing outward toward the given environment.

Further, such an apparatus additionally includes a control system comprising at least one algorithm configured to process data measured by the set of one or more sensors and engage at least a portion of the one or more electric actuators based at least in part on the processed data (for example, one or more of the actuators can be engaged at least in part by one or more sensors). Also, one or more embodiments can additionally include at least one (cinema) camera mount connected to the frame. For example, the at least one algorithm can include a data smoothing algorithm and/or a simultaneous location and mapping algorithm configured to determine one or more positions of the apparatus by processing a series of images of the given environment captured by the one or more imaging sensors. Additionally or alternatively, the at least one algorithm can include at least one algorithm configured to design one or more motion data trajectories for the apparatus, wherein such an algorithm comprises a position function and a velocity function. In such an embodiment, the position function includes a two-dimensional or a three-dimensional parameterized function that details a path beginning at an initial point and ending at a terminal point, and the velocity function includes a function of one variable that describes the velocity of the apparatus during the path. Also, in one or more embodiments, a trajectory can be replicated multiple times for each “take” (that is, each filmed version of a particular shot or setup).

At least one embodiment can also include at least one motorized vertical axis connected to the frame and/or camera mount, at least one motorized pan and tilt gimbal connected to the frame and/or camera mount, and/or electrical power supplied by a rechargeable battery and/or wall power.

Further, one or more embodiments includes enabling capabilities to read and write to at least one persistent database that stores trajectory information and allows for querying, filtering, and/or sorting of trajectories for later use. Also, at least one embodiment includes a multi-client architecture wherein multiple clients can exercise varying levels of remote control over the axes of movement of the apparatus (e.g., a mobile robotic camera platform) depending on the mode of operation. Remote control can be provided, for instance, over a wireless network wherein the apparatus acts as a server. Coordination of which users control which axes can be done at the server, and clients can access telemetry data from the apparatus via at least one network.

Other techniques can be used in association with one or more embodiments of the invention. Accordingly, the particular processing operations and other network functionality described in conjunction with FIG. 3 are presented by way of illustrative example only, and should not be construed as limiting the scope of the invention in any way. For example, the ordering of the process steps may be varied in one or more other embodiments of the invention, or certain steps may be performed concurrently with one another rather than serially. Also, the process steps or subsets thereof may be repeated periodically in conjunction with respective distinct instances of camera usage (e.g., filming) with respect to different users.

The above-described example embodiments of the invention provide significant advantages relative to conventional approaches. For example, one or more embodiments of the invention can include a mobile/portable camera motion control system that does not require the use of rail systems or cranes. Additionally, one or more embodiments include a specialized wheel module in which the heading of each wheel can be actuated independently, enabling the platform/system to drive/move on the ground in any direction.

It is to be appreciated that the foregoing advantages are illustrative of advantages provided in certain embodiments, and need not be present in other embodiments.

Additionally, the networks disclosed herein can be implemented, for example, using one or more processing platforms. Such a processing platform can include, by way of example, at least one processing device comprising a processor coupled to a memory.

In one or more embodiments of the invention, portions of a network as disclosed herein can illustratively include cloud infrastructure. For example, one such example embodiment can include a system that allows the automatic backup of motion data to a cloud-based system such that the motion data are accessible from an online account of one or more mobile robotic camera platforms. The cloud infrastructure, in at least one such embodiment of the invention, can include a plurality of containers implemented using container host devices, and/or can include container-based virtualization infrastructure configured to implement Docker containers or other types of Linux containers.

The cloud infrastructure can additionally or alternatively include other types of virtualization infrastructure such as virtual machines implemented using a hypervisor. Additionally, the underlying physical machines include one or more distributed processing platforms that include one or more storage systems.

Such cloud infrastructure as described above can, by way of example, represent at least a portion of one processing platform. Another example of such a processing platform can include, as similarly detailed above in connection with FIG. 1, a plurality of processing devices which communicate with one another over a network. As yet another processing platform example, portions of a given processing platform in one or more embodiments of the invention can include converged infrastructure.

The particular processing platforms described above are presented by way of example only, and a given network such as network 100 can include additional or alternative processing platforms, as well as numerous distinct processing platforms in any combination, with each such platform comprising one or more computers, servers, storage devices and/or other processing devices.

Further, in accordance with one or more embodiments of the invention, processing devices and other network components can communicate with one another using a variety of different communication protocols and associated communication media.

It should again be emphasized that the embodiments of the invention described herein are presented for purposes of illustration only. Many variations may be made in the particular arrangements shown. Moreover, the assumptions made herein in the context of describing one or more illustrative embodiments of the invention should not be construed as limitations or requirements of the invention, and need not apply in one or more other embodiments of the invention. Numerous other alternative embodiments within the scope of the appended claims will be readily apparent to those skilled in the art.

What is claimed is:

1. An apparatus comprising:
a frame;
a multi-wheeled motorized base connected to the frame, wherein the multi-wheeled motorized base provides one or more translational axes;
one or more electric actuators connected to the multi-wheeled motorized base;
a set of one or more sensors configured to determine a location of the apparatus relative to a given environment; and
a control system comprising at least one algorithm configured to process data measured by the set of one or more sensors and engage at least a portion of the one or more electric actuators based at least in part on the processed data.

2. The apparatus of claim 1, wherein the one or more sensors comprise one or more rotational encoders configured to measure a rotational position of at least a portion of the one or more electric actuators.

3. The apparatus of claim 1, wherein the set of one or more sensors comprise one or more imaging sensors integral to the apparatus and positioned pointing outward toward the given environment.

4. The apparatus of claim 3, wherein the at least one algorithm comprises a simultaneous location and mapping algorithm configured to determine one or more positions of the apparatus by processing a series of images of the given environment captured by the one or more imaging sensors.

5. The apparatus of claim 1, wherein the at least one algorithm comprises at least one data smoothing algorithm.

6. The apparatus of claim 1, wherein the at least one algorithm is configured to design one or more motion data trajectories for the apparatus.

7. The apparatus of claim 6, wherein the at least one algorithm configured to design one or more motion data trajectories for the apparatus comprises a position function and a velocity function.

8. The apparatus of claim 7, wherein the position function comprises a two-dimensional or a three-dimensional parameterized function that details a path beginning at an initial point and ending at a terminal point.

9. The apparatus of claim 8, wherein the velocity function comprises a one-dimensional function that details the velocity of the apparatus during the path.

10. The apparatus of claim 1, further comprising:
at least one motorized vertical axis connected to the frame.

11. The apparatus of claim 1, further comprising:
at least one motorized pan and tilt gimbal connected to the frame.

12. A computer-implemented method comprising:
recording motion data of a mobile robotic camera platform, wherein the motion data corresponds to a user-designed set of movements;
generating modified motion data by applying one or more smoothing algorithms to the recorded motion data;
configuring the mobile robotic camera platform to automatically perform a set of movements corresponding to the modified motion data, wherein configuring the mobile robotic camera platform comprises implementing one or more motion control algorithms; and
detecting and adjusting movement of the mobile robotic camera platform during performance of the set of movements corresponding to the modified motion data by implementing one or more sensors;
wherein the method is carried out by at least one computing device.

13. The computer-implemented method of claim 12, wherein implementing the one or more motion control algorithms comprises implementing (i) at least one algorithm directed to sensor sampling, fusion, and simultaneous location and mapping, (ii) at least one algorithm directed to trajectory planning and execution, (iii) at least one algorithm directed to inverse kinematics, and (iv) at least one algorithm directed to closed-loop feedback control.

14. The computer-implemented method of claim 12, wherein the user-designed set of movements comprises movements of the mobile robotic camera platform manipulated manually or via one or more input devices.

15. The computer-implemented method of claim 12, wherein the user-designed set of movements comprises movements of the mobile robotic camera platform constrained by a control system to at least a two-dimensional virtual path stored in memory, wherein velocity of the mobile robotic platform on the virtual path is user-controlled.

16. The computer-implemented method of claim 12, wherein the user-designed set of movements comprises automated movement of the mobile robotic camera platform between two or more user-determined setpoints.

17. The computer-implemented method of claim 12, wherein the motion data comprise at least one computer-generated graphic representation of movements of the mobile robotic camera platform.

18. A computer program product comprising a computer readable storage medium having program instructions embodied therewith, the program instructions executable by a computing device to cause the computing device to carry out the method of claim 12.

19. A system comprising:
a memory; and
at least one processor operably coupled to the memory and configured for:
recording motion data of a mobile robotic camera platform, wherein the motion data corresponds to a user-designed set of movements;
generating modified motion data by applying one or more smoothing algorithms to the recorded motion data;
configuring the mobile robotic camera platform to automatically perform a set of movements corresponding to the modified motion data, wherein configuring the mobile robotic camera platform comprises implementing one or more motion control algorithms; and
detecting and adjusting movement of the mobile robotic camera platform during performance of the set of movements corresponding to the modified motion data by implementing one or more sensors.

20. The system of claim 19, wherein implementing the one or more motion control algorithms comprises implementing (i) at least one algorithm directed to sensor sampling, fusion, and simultaneous location and mapping, (ii) at least one algorithm directed to trajectory planning and execution, (iii) at least one algorithm directed to inverse kinematics, and (iv) at least one algorithm directed to closed-loop feedback control.
